(19) United States
(12) Patent Application Publication
(10) Pub. No.: US 2014/0164338 A1
(43) Pub. Date: Jun. 12, 2014

(54) ORGANIZING INFORMATION DIRECTORIES

(71) Applicant: HEWLETT-PACKARD DEVELOPMENT COMPANY, L.P., Houston, TX (US)

(72) Inventors: Charles Hickman, Bristol (GB); April Slayden Mitchell, San Jose, CA (US)

(73) Assignee: Hewlett-Packard Development Company, L.P., Houston, TX (US)

(21) Appl. No.: 13/710,574

(22) Filed: Dec. 11, 2012

(51) Int. Cl. G06F 17/30

(52) U.S. Cl. CPC G06F 17/30864
USPC 707/692; 707/709

(57) ABSTRACT

Building an information directory can include sending source data to an information extractor, wherein the source data includes first source metadata, extracting second source metadata using the source data, using the information extractor, merging the first source metadata and the second source metadata into third source metadata, and organizing the third source metadata in the information directory.

### BACKGROUND

An information directory can include a catalogue of information that represents relationships between the information. Such information can include users (e.g., employees) and the relationships between each user (e.g., worked together, interests, and/or experience). An organization (e.g., entity, company, and/or employer) can use an information directory to identify and/or encourage collaboration between users.

### BRIEF DESCRIPTION OF THE DRAWINGS

FIG. 1 illustrates a block diagram of an example environment for organizing an information directory according to the present disclosure.

FIG. 2 is a block diagram illustrating an example of a method for building an information directory.

FIG. 3 illustrates an example system including a computing device according to the present disclosure.

### DETAILED DESCRIPTION

Organizations can use collaboration tools to allow for an effective work environment. A collaboration tool may be computer-readable instructions coupled to a processor that enable users to work together. For instance, organizations may use tools that allow users to track the projects others are working on, to identify interests of specified persons, and/or to identify developments in a particular area of interest to the user. Such collaboration tools may be effective and useful, but require time and data input to become useful sources of information. For instance, users may interact with the tool by declaring their areas of expertise, declaring what they are looking for, and/or declaring what projects they are interested in. Once users in an organization interact with collaboration tools for a period of time, the user may realize a benefit in the tools. Benefits of utilizing collaboration tools may include, for example, identifying relationships between people, identifying areas of interests of particular individuals, and/or tracking progress of a project.

In contrast, organizing an information directory in accordance with examples of the present disclosure can recognize relationships and interests of users with less interaction than collaboration tools. An information directory that recognizes a user on the first day of use may allow the user to realize these benefits with less interaction. The information directory may store, organize, and/or display information that is a part of an organization's everyday operations, and allow users to identify the contextual relationships between people, projects, and/or topics of interest.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N”, “P”, “R”, and “S” particularly with respect to reference numerals in the drawings, indicate that a number of the particular feature so designated can be included with a number of examples of the present disclosure. Also, as used herein, “a number of” an element and/or feature can refer to one or more of such elements and/or features.

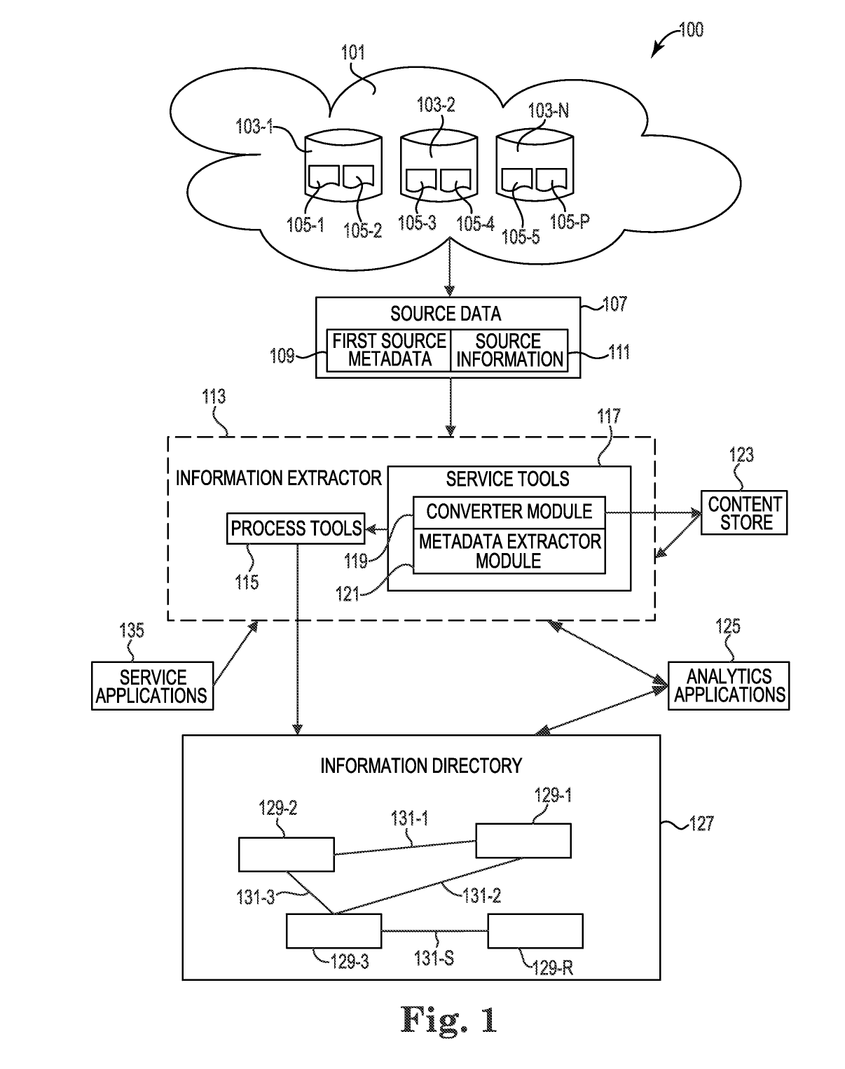

FIG. 1 illustrates a block diagram of an example environment 100 for organizing an information directory according to the present disclosure. The environment may include a variety of components, including a network 101, an information extractor 113, and an information directory 127. The information extractor 113 may be computer-readable instructions, coupled to a processor, that extract information from an unstructured and/or semi structured computer-readable document. The information extractor 113 may act as an intermediate between the network 101 and the information directory 127. The network 101 may be a public network such as the Internet, a private network such as a corporate intranet, or a combination of a public network and a private network.

As illustrated in FIG. 1, a network 101 may include a number of silos 103-1, 103-2, . . . , 103-N. A silo can be a storage system that stores a source. As an example, silo 103-1 can store source 105-1. A silo can include a repository, among other source storage systems. For example, a silo may include a file folder, a shared directory, a blog site, a slideset, and/or a Rich Site Summary (RSS) feed of content that has been published, among other repositories. Each silo may include a plurality of sources and/or a single source. A source may be, for example, a document, a presentation, a web page, an image, a video, or any other information source stored in a silo. For example, silo 103-2 can include sources 105-3 and 105-4. Thereby, the network 101 may include a number of sources 105-1, 105-2, 105-3, . . . , 105-P. However, examples are not so limited. In some examples, the network 101 may include one silo (e.g., silo 103-1) which includes one source (e.g., source 105-1).

A crawler may scan a network 101 and extract source data 107 from a particular source (e.g., 105-2) within a silo (e.g., 103-1). A crawler, as used herein, can be an application and/or a program such as a web crawler, a web spider, and/or other probe that continually and/or periodically scans the network 101 to collect source data 107. The crawler may scan a number of networks (e.g., network 101) in an orderly, automated manner, and collect source data 107. A crawler can include computer-readable instructions executed by a processor to index a number of sources.

Source data 107 may include source information 111 and/or first source metadata 109. Source information 111 may be information identifying the location of a source 105-1, . . . , 105-P in network 101. Source information 111 may include a Uniform Resource Locator (URL), among other locators.

First source metadata 109, as used herein, can include information obtained from a source itself. First source metadata 109 may be data unique to a source 105-1, . . . , 105-P (e.g., particular source 105-4) and/or first source metadata 109 may be data that does not exist in the source itself. For example, the particular source 105-4 can be a presentation, and the first source metadata 109 can be documents referenced by the presentation. In another example, the particular source 105-4 can be a document, and the first source metadata 109 can be tags identified in the document. First source metadata 109 may be preserved for storage in the information directory 127, as discussed further herein.

As illustrated in FIG. 1, source data 107 may be sent to an information extractor 113. The information extractor may be computer-readable instructions, coupled to a processor, that when executed by the processor can perform a number of functions, as discussed further herein.

The information extractor 113 may be a broker between a crawler and an information directory 127, allowing for preservation of first source metadata 109 and extraction of second source metadata. The information extractor 113 may use service tools 117 and the source information 111 to access a source 105-1, . . . , 105-P. A service tool 117 may be computer-readable instructions, coupled to a processor, that when executed by the processor can perform a number of functions. The service tool 117 may include sub-modules (e.g. converter module 119 and metadata extractor module 121). The metadata extractor module 121 may extract second source metadata from a source 105-1, . . . , 105-P. In some examples of the present disclosure, the information extractor 113 may include a sub-module that extracts information about people and the relationships between those people. As discussed herein, the second-source metadata may be different from first source metadata. However, examples are not so limited, and second source metadata may include information partially or completely included in first source metadata 109.

Second source metadata, as discussed further herein, can include information describing the contents and context of the source. Second source metadata, can include information associated with the source. For instance, second source metadata may be information extracted from the site where the source originated. For example, a source 105-1, . . . , 105-P (e.g., particular source 105-1) can be a word document posted in a shared directory, and the second source metadata 109 can be names of persons who worked on the document, as listed in the shared directory. Second source metadata may include data specifying a language the source was written in, a name of an author of the source, a date and time corresponding to when the source was created, tools used to create the source, where to go for more information pertaining to the source, tags from within the source, and/or other types of information describing the contents and context of the source 105-1, . . . , 105-P.

The converter module 119 can comprise computer-readable instructions that can be executed by the processor to extract text from the source 105-1, . . . , 105-P and convert the extracted text to plain text (e.g., text from a Portable Document Format document can be converted to plain text). Plain text can include basic, interchangeable content of the source, absent formatting. In some examples of the present disclosure, the information extractor 113 may send the plain text to a content store 123 for retrieval by analytics applications 125, as discussed further herein.

The information extractor 113 may use process tools 115 to preserve the first source metadata 109 and/or merge the first source metadata 109 with second source metadata to create third source metadata. Third source metadata can include a unified set of metadata.

The information extractor 113 may send third source metadata to an information directory 127. The information directory 127 may be a hierarchy of information pertaining to an organization. In some examples of the present disclosure, the information directory 127 may be a comprehensive graph displaying representations of sources and the third source metadata. The information directory 127 may organize the sources and third source metadata. For instance, references to people, documents, and tags, as well as the contextual relationships between them, can be organized in a graph with textual and/or graphical representations.

In some examples of the present disclosure, the information extractor 113 may use process tools 115 to identify if the third source metadata exists in the information directory 127. The information extractor 113 may add the third source metadata to the information directory 127 in response to identifying that the third source metadata does not exist in the information directory 127. The information extractor 113 may identify that the information directory 127 contains the third source metadata, but determine that the third source metadata is out-of-date. Out-of-date third source metadata can include incomplete and/or non-updated third source metadata. For example, third source metadata associated with a particular source (e.g., a document) may include a non-updated date of a last revision. The information extractor 113 may update the identified out-of-date third source metadata, for instance, by including the updated date of the last revision.

A source 105-1, . . . , 105-P may be displayed and/or represented in the information directory 127 as a node 129-1, 129-2, 129-3, . . . , 129-R. For example, a source (e.g., particular source 105-1) can be a document, and can be represented in the information directory 127 as node 129-1.

Third source metadata may be displayed and/or represented in the information directory 127 as a node 129-1, . . . , 129-R and/or an edge 131-1, 131-2, 131-3, . . . , 131-S. For example, third source metadata may include a person (e.g., Jim Jones), and can be represented in the information directory 127 as node 129-2. In another example, third source metadata may include a relationship, such as “worked with”, and can be represented in the information directory 127 as an edge 131-1, . . . , 131-S.

An edge (e.g., edge 131-3) may connect a first node (e.g., node 129-2) with a second node (e.g., node 129-3) in the information directory 127. The edge 131-3 may represent a particular relationship between the first node 129-2 and the second node 129-3. Relationships represented by an edge may include authored, interested in, worked on, worked with, experience in, manages, knows, owns, collects, similarity, and/or relates to, among other types of relationships.

The information directory 127 may include a number of edges, 131-1, . . . , 131-S. For example, node 129-1 representing a document, may be connected to node 129-2 representing Jim Jones, with an edge 131-1 representing that Jim Jones authored the document. In another example, node 129-3 representing Sharon Silver, may be connected to node 129-2 representing Jim Jones, with an edge 131-2 representing that Sharon Silver works with Jim Jones.

A first node may be connected to more than one second node in an information directory 127. For example, a node 129-1 representing a document, may be connected to a node 129-3 representing Sharon Silver, and to a node 129-2 representing Jim Jones, by edges 131-2 and 131-1 representing that Sharon Silver and Jim Jones, respectively, authored the document. In other words, a first node may be connected to a number of second nodes by a number of edges, wherein each edge represents one of a number of relationships.

In some examples of the present disclosure, an information extractor 113 may send plain text (e.g., text extracted and converted from the source by the converter) to a content store 123 for retrieval by an analytics application 125. The analytics application 125 can comprise computer-readable instructions that can be executed by a processor to analyze nodes 129-1, . . . , 129-R and edges 131-1, . . . , 131-S in an information directory 127. The analytics application 125 may access the plain text of a source (e.g., particular source 105-1), in the content store 123 and identify new relationships between the source and other sources and/or third source metadata. A new relationship may include a relationship that did not previously exist, and/or a relationship that previously existed but was not represented in the information directory 127. Thereby, the analytics application 125 may analyze the information directory 127, analyze the plain text in the content store 123, and/or identify new edges connecting nodes in the information directory 127.

In some examples of the present disclosure, the content store 123 may store a copy of the plain text from a source 105-1, . . . , 105-P for retrieval by service applications 135. Service applications 135 may be services that run on top of the information directory 127 (e.g., an enterprise collaboration service). The content store 123 may communicate with the information extractor 113 to respond to requests from the service applications 135 for access to the sources 105-1, . . . , 105-P.

In various examples of the present disclosure, if a service application 135 requests access to the plain text of a source and the plain text does not exist in the content store 123, the information extractor 113 may extract text from the source 105-1, . . . , 105-P and convert the text to plain text. If the service application 135 requests access to the plain text of a source 105-1, . . . , 105-P and a specified threshold (e.g., target threshold) of time is exceeded, the information extractor 113 may implement a timeout. A timeout can include regenerating the plain text using the information extractor 113 upon request from a service application 135 and/or an analytics application 125.

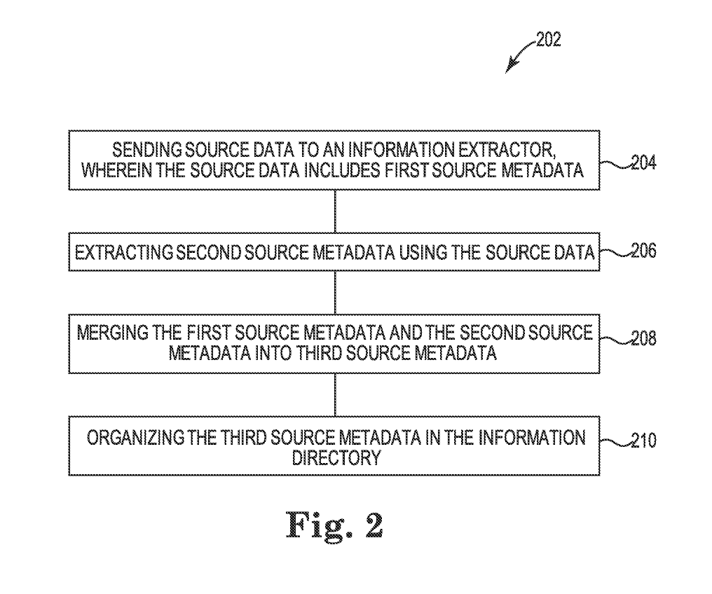

FIG. 2 is a block diagram illustrating an example of a method 202 for building an information directory. At 204, source data is sent from a crawler to an information extractor. The crawler may scan a particular source, within a particular silo, on a network and collect source data. Source data, as described herein, may include first source metadata and source information.

First source metadata (e.g., first source metadata 109) may be information that exists in the source itself. First source metadata may include the title of a document, who authored it, and tags that are embedded in the document. First source metadata may be created automatically using an application module (e.g. computer-readable instructions) and/or associated with a source manually.

Source information (e.g., source information 111) may be information identifying the location of a source in a network. Source information may include a Uniform Resource Locator (URL), among other locators.

At 206, second source metadata is extracted from the source, using an information extractor (e.g. information extractor 113) and the source information. Second source metadata may be information about a source that does not exist in the source itself (e.g., information about how the source was formatted and/or when and/or by whom it was collected). Example second source metadata may include related documents and tags from the site where the source is located. In another example, second source metadata may include the titles of documents that an author also wrote. However, examples are not so limited and the second source metadata may include the same information and/or a sub-portion of information included in the first source metadata.

At 208, second source metadata is merged with first source metadata into third source metadata. Third source metadata can include a unified set of metadata. The information extractor may remove duplicate metadata, such that third source metadata includes information among and/or in the first source metadata, and information among and/or in the second source metadata that is not among and/or in the first source metadata. Thereby, the third source metadata can include the first source metadata and at least a subportion of the second source metadata, wherein the at least subportion of the second source metadata includes information that is not represented in the first source metadata (e.g., information and/or metadata unique to the second source metadata).

At 210, the third source metadata can be organized in an information directory (e.g., information directory 127). The information directory may identify relationships between the user and other users within an organization, identify relationships between projects the user worked on and projects other users within the organization worked on, and/or identify relationships between the user and a number of organizations, for example. Sources and/or third source metadata may be used to create nodes (e.g., nodes 129-1, . . . , 129-R) within the information directory. Third source metadata may be used to connect nodes within the information directory. The information directory may be displayed on a user interface that allows users to interact with the computing device using images rather than text commands (e.g. a Graphical User Interface).

Nodes may be connected to other nodes with edges representing one of a number of relationships in the information directory. Each relationship represented by an edge may be represented by a different type, pattern, and/or weight of line on the user interface. In some examples, each relationship represented by an edge may be labeled with a textual identifier. A textual identifier may identify the relationship between two nodes.

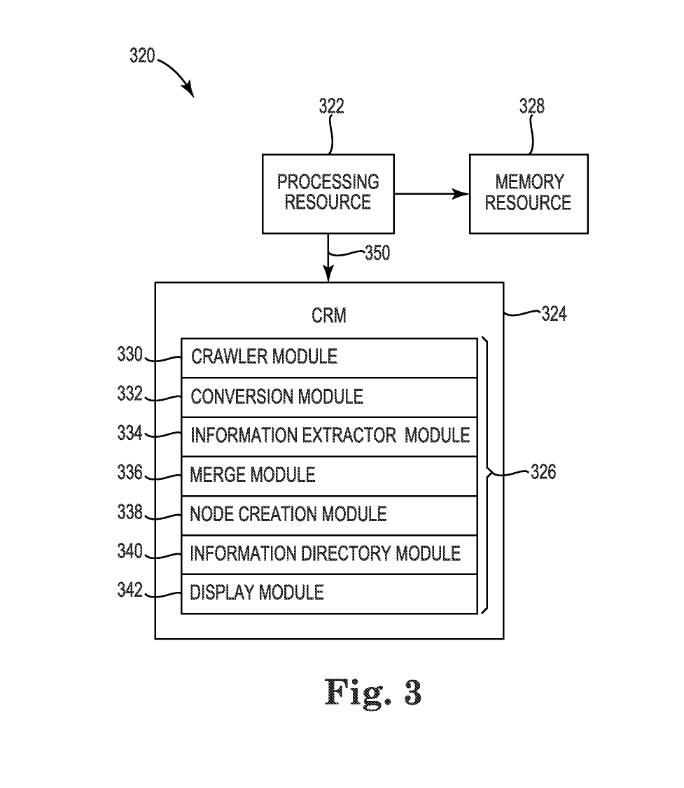

FIG. 3 illustrates an example system including a computing device 320 according to the present disclosure. The computing device 320 can use software, hardware, firmware, and/or logic to perform a number of functions.

The computing device 320 can be a combination of hardware and program instructions configured to perform a number of functions. The hardware, for example can include a number of processing resources 322, computer-readable medium (CRM) 324, etc. The program instructions (e.g., computer-readable instructions (CRI) 326) can include instructions stored on the CRM 324 and executable by the processing resources 322 to implement a desired function (e.g., passing source data to an information extractor, etc.).

CRM 324 can be in communication with a number of processing resources of more or fewer than 322. The processing resources 322 can be in communication with a tangible non-transitory CRM 324 storing a set of CRI 326 executable by a number of the processing resources 322, as described herein. The CRI 326 can also be stored in remote memory managed by a server and represent an installation package that can be downloaded, installed, and executed. The computing device 320 can include memory resources 328, and the processing resources 322 can be coupled to the memory resources 328.

Processing resources 322 can execute CRI 326 that can be stored on an internal or external non-transitory CRM 324. The processing resources 322 can execute CRI 326 to perform various functions, including the functions described in FIGS. 1-2.

The CRI 326 can include a number of modules 330, 332, 334, 336, 338, 340, and 342. The number of modules 330, 332, 334, 336, 338, 340, and 342 can include CRI 326 that when executed by the processing resources 322 can perform a number of functions.

The number of modules 330, 332, 334, 336, 338, 340, and 342 can be sub-modules of other modules. For example, the node creation module 338 and the information directory module 340 can be sub-modules and/or contained within a single module. Furthermore, the number of modules 330, 332, 334, 336, 338, 340, and 342 can comprise individual modules separate and distinct from one another.

A crawler module 330 can comprise CRI 326 that can be executed by the processing resources 322 to index first source metadata and source information. Indexing first source metadata and source information can include listing first source metadata and source information in a manner to provide increased speed of searching.

A conversion module 332 can comprise CRI 326 executable by the processing resources 322 to convert the text from a source to plain text. Plain text from a source may be stored in a content store for retrieval by analytics applications. In some examples, the plain text stored in the content store may be retrieved by service applications running on top of the information directory, such as an enterprise collaboration service.

An information extractor module 334 can comprise CRI 326 executable by the processing resources 322 to extract second source metadata from the source using the source information. Second source metadata may and/or may not differ in content and/or context from first source metadata.

A merge module 336 can comprise CRI 326 executable by the processing resources 322 to merge second source metadata and first source metadata to create third source metadata. Third source metadata may include first source metadata and second source metadata. In some examples of the present disclosure, at least a subportion of the first source metadata and at least a subportion of the second source metadata may include the same information. In such an example, the merge module 336 can remove the duplicate source metadata (e.g., remove the at least subportion of the first source metadata or the at least subportion of the second source metadata that includes the same information).

A node creation module 338 can comprise CRI 326 executable by the processing resources 322 to create nodes in an information directory using a first subportion of the third source metadata. A node may represent a source and/or third source metadata. For example, a particular source (e.g., a document) may be represented in the information directory as a node. In another example, the first subportion of the third source metadata may represent a person or a tag in the information directory as a node.

An information directory module 340 can comprise CRI 326 executable by the processing resources 322 to organize the nodes in the information directory using a second subportion of the third source metadata. The second subportion of the third source metadata may be used to identify relationships between nodes in the information directory.

In some examples, the system can include an analytics application module. An analytics application module (e.g., not illustrated in the example of FIG. 3) can comprise CRI executable by the processing resources 322 to analyze the contents of the information directory and/or the plain text in the content store and suggest tags that the information extractor should extract from a source in the network. The analytics application module may include sub-modules (e.g., CRI, executable by a processor) that analyze a particular portion of the information directory and/or the content store. For example, a sub-module may identify similar video sources, similar source summaries, and/or related sources. In some examples, sub-modules of the analytics application module may analyze the contents of the information directory and/or the content store according to user configurable search instructions.

In various examples of the present disclosure, the system can include a display module 342. A display module 342 can comprise CRI 326 executable by the processing resources 322 to display a representation of the information directory on a user interface. For instance, the representation can be in response to a query of the information directory and/or the analytics applications by a user using the display module. The user interface may include a personalized view, specific to the particular user accessing the information directory. For example, Jane Doe accesses the display module to query the information directory and/or the analytics applications, a user interface may display that identifies Jane Doe as a person, identifies the individuals that report to Jane Doe and the projects they are working on, as well as colleagues of Jane Doe, projects that Jane Doe has worked on, and/or projects that Jane Doe might be interested in.

A non-transitory CRM 324, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, and/or a solid state drive (SSD), etc., as well as other types of computer-readable media.

The non-transitory CRM 324 can be integral, or communicatively coupled, to a computing device, in a wired and/or a wireless manner. For example, the non-transitory CRM 324 can be an internal memory, a portable memory, a portable disk, or a memory associated with another computing source (e.g., enabling CRIs 326 to be transferred and/or executed across a network such as the Internet).

The CRM 326 can be in communication with the processing resources 322 via a communication path 350. The communication path 350 can be local or remote to a machine (e.g., a computer) associated with the processing resources 322. Examples of a local communication path 350 can include an electronic bus internal to a machine (e.g., a computer) where the CRM 324 is one of volatile, non-volatile, fixed, and/or removable storage medium in communication with the processing resources 322 via the electronic bus.

The communication path 350 can be such that the CRM 324 is remote from the processing resources, (e.g., processing resources 322) such as in a network connection between the CRM 324 and the processing sources (e.g., processing resources 324). That is, the communication path 350 can be a network connection. Examples of such a network connection can include a local area network (LAN), wide area network (WAN), personal area network (PAN), and the Internet, among others. In such examples, the CRM 324 can be associated with a first computing device and the processing resources 322 can be associated with a second computing device (e.g., a Java® server). For example, a processing resource 322 can be in communication with a CRM 324, wherein the CRM 324 includes a set of instructions and wherein the processing resource 322 is designed to carry out the set of instructions.

As used herein, “logic” is an alternative or additional processing resource to perform a particular action and/or function, etc., described herein, which includes hardware (e.g., various forms of transistor logic, application specific integrated circuits (ASICs), etc.), as opposed to computer executable instructions (e.g., software, firmware, etc.) stored in memory and executable by a processor.

As used herein, “a” or “a number of” something can refer to one or more such things. For example, “a number of processor resources” can refer to one or more processor resources.

What is claimed:

1. A computer implemented method of organizing an information directory comprising:
sending source data to an information extractor, wherein the source data includes first source metadata;
extracting second source metadata using the source data;
merging the first source metadata and the second source metadata into third source metadata; and
organizing the third source metadata in the information directory.

2. The method of claim 1, wherein the source data includes source information.

3. The method of claim 1, comprising preserving the first source metadata for storage in the information directory.

4. The method of claim 1, wherein the first source metadata includes a tag, a person, and a date.

5. The method of claim 1, comprising representing a subportion of the third source metadata as a first node in the information directory, wherein the first node is connected to a second node with an edge representing a relationship.

6. A non-transitory computer-readable medium storing a set of instructions executable by a processing resource to cause a computer to:
receive source data from a crawler, wherein source data includes source information and first source metadata associated with a source;
send the source data from the crawler to an information extractor;
extract second source metadata from the source using the source information and the information extractor;
merge the first source metadata and the second source metadata into third source metadata; and
organize the third source metadata and the source in the information directory.

7. The non-transitory computer-readable medium of claim 6, wherein the instructions to merge the first source metadata and the second source metadata comprise instructions executable to remove duplicate metadata.

8. The non-transitory computer-readable medium of claim 6, wherein the instructions are executable to extract text of a source, convert the text to plain text, and store the plain text in a content store.

9. The non-transitory computer-readable medium of claim 6, wherein the instructions are executable to verify the information directory contains the third source metadata.

10. The non-transitory computer-readable medium of claim 6, wherein the instructions are executable to add the third source metadata to the information directory using the information extractor in response to identifying the information directory does not contain the third source metadata.

11. The non-transitory computer-readable medium of claim 6, wherein the instructions are executable to update the third source metadata in the information directory using the information extractor, in response to identifying the information directory contains an incomplete version of the third source metadata.

12. A system for building an information directory, the system comprising:
a memory resource;
a processing resource coupled to the memory resource to implement:
a crawler module comprising computer-readable instructions stored on the memory resource and executable by the processing resource to send first source metadata and source information from a crawler to an information extractor;
a conversion module comprising computer-readable instructions stored on the memory resource and executable by the processing resource to:
extract text from a source;
convert the text to plain text; and
store the plain text in a content store;
an information extractor module comprising computer-readable instructions stored on the memory resource and executable by the processing resource to extract second source metadata from the source using the source information;
a merge module comprising computer-readable instructions stored on the memory resource and executable by the processing resource to merge the first source metadata and the second source metadata into third source metadata;
a node creation module comprising computer-readable instructions stored on the memory resource and executable by the processing resource to create nodes in an information directory using a first subportion of the third source metadata; and
an information directory module comprising computer-readable instructions stored on the memory resource and executable by the processing resource to organize the nodes in the information directory using a second subportion of the third source metadata to identify relationships between the nodes.

13. The system of claim 11, wherein the processing resource is coupled to the memory resource to implement a display module comprising computer-readable instructions stored on the memory resource and executable by the processing resource to display a representation of the information directory on a user interface.

14. The system of claim 11, wherein the processing resource is coupled to the memory resource to implement an analytics application module comprising computer-readable instructions stored on the memory resource to analyze the information directory and the content store to identify a relationship between a first node and a second node.

15. The system of claim 11, wherein the processing resource is coupled to the memory resource to implement a text retrieval module comprising computer-readable instructions stored on the memory resource to send a request to the information extractor for access to the plain text.
